(19) United States
(12) Patent Application Publication
(10) Pub. No.: US 2012/0141863 A1
(43) Pub. Date: Jun. 7, 2012

(54) ELECTROCHEMICAL DEVICE

(75) Inventor: Naoto HAGIWARA, Tokyo (JP)

(73) Assignee: TAIYO YUDEN CO., LTD., TOKYO (JP)

(21) Appl. No.: 13/305,356

(22) Filed: Nov. 28, 2011

(30) Foreign Application Priority Data
Dec. 3, 2010 (JP) 2010-270157

(51) Int. Cl. H01M 2/02

(52) U.S. Cl. 429/163

(57) ABSTRACT

Various embodiments of the present disclosure provide an electrochemical device that enables each of a plurality battery elements to be appropriately charged and, thereby, meet the demand for higher voltage even when said plurality of battery elements are connected in electrically series between a pair of electrodes. Electrochemical device 10 comprises a pair of concave portions 11a formed on case 11. The concave portions 11a are sealed by lid 13 in a watertight and air tight manner. Enclosed into the sealed concave portions 11a are battery elements 14 that are connected in electrically series via wiring 15a and 16a between a pair of electrodes 15 and 16. Disposed on the mount surface of the case 11 is intermediate electrode 17 that is electrically connected via wiring 17a to the injunction between the pair of battery elements 14.

### CROSS-REFERENCE TO RELATED APPLICATIONS

This application is based upon and claims the benefit of priority from prior Japanese Patent Application No. 2010-270157, filed Dec. 3, 2010 titled “ELECTROCHEMICAL DEVICE,” the entire contents of which are incorporated herein by reference.

### FIELD OF THE INVENTION

This disclosure relates to electrochemical devices that encapsulate chargeable and dischargeable battery elements.

### BACKGROUND

Surface-mountable electrochemical devices, such as electric double layer capacitors and lithium-ion batteries, are being used as a memory backup power source for cell phones, laptop computers, video cameras, digital cameras and other types of electronic devices.

Japanese Patent Application Publication No. 2009-278068 discloses a conventional electrochemical device comprising a case having a concave portion, a lid for sealing the concave portion in a watertight and air tight manner, dischargeable battery elements and electrolytic solutions each enclosed in the sealed concave portion, a pair of electrodes (positive electrode and negative electrode) provided on the mount surface of the case, wirings for electrically connecting each of the pair of electrodes and the battery elements.

The nominal voltage of said electrochemical devices used as memory backup power source is typically 2-4 V. Recently, a higher level of nominal voltage is desired to accommodate a wider range of applications. Japanese Patent Application Publication No. 2005-123154 (the “'154 Publication”) discloses an electrochemical device comprising a pair of battery elements which are connected to one another in electrically series so as to supply higher voltage. The electrochemical device described in the '154 Publication may have a higher nominal voltage by electrically connecting the enclosed battery elements in series that are enclosed into a case having a plurality of sealed concave portions.

However, due to variations in charge/discharge characteristic of each of the battery elements, while some of the battery elements are fully charged, the remaining battery elements may not be sufficiently charged, which may cause the pair of electrodes not to evenly charge each of the battery elements. Thus, the conventional charging mechanism may degrade the actual nominal voltage of the electrochemical device.

### SUMMARY

Various embodiments of the present disclosure provide an electrochemical device that enables each of a plurality battery elements to be appropriately charged and, thereby, meet the demand for higher voltage even when said plurality of battery elements are connected in electrically series between a pair of electrodes.

Various embodiments disclosed herein achieving these and other objects relate to an electrochemical device, comprising a case including a plurality of concave portions; a lid for sealing the plurality of concave portions of the case in a watertight and air tight manner; a plurality of chargeable and dischargeable battery elements each of which is enclosed into a corresponding one of the sealed plurality of concave portions together with a corresponding electrolytic solution, the plurality of battery elements being connected in series; a pair of electrodes formed on a mount surface of the case; a wiring for electrically connecting each of the pair of electrodes to the battery elements; and an intermediate electrode formed on the mount surface of the case, the intermediate electrode being electrically connected via the wiring to a junction between adjacent two of said plurality of battery elements; wherein said plurality of battery elements are electrically connected to one another via the wiring between said pair of electrodes.

The electrochemical device in accordance with various embodiments is configured such that the intermediate electrode is electrically connected to the junction between the adjacent two battery elements that are connected in electrically series between the positive and negative electrodes. Accordingly, in case the plurality of battery elements consist of, for example, two battery elements, one of the battery elements may be charged by use of the positive electrode and the intermediate electrode, and the other of the battery elements may be charged by use of the negative electrode and the intermediate electrode.

Thus, charging of each of the battery elements may be carried out independently of one another (i.e., charging may be carried out on an individual battery element basis), while the plurality of battery elements are disposed in electrically series between the positive electrode and the negative electrode. As such, despite variation in charge/discharge characteristic of each of the battery elements, it is possible to avoid the phenomenon as observed in the conventional art that some of the battery elements are fully charged but the remainings are insufficiently charged, and, therefore, charging of each of the battery elements may be carried out in accordance with the charge/discharge characteristic thereof. Consequently, the electrochemical device in accordance with various embodiments may have a nominal voltage twice or nearly twice as high as that of the individual battery element, thereby meeting the recent demand for high voltage.

In accordance with various embodiments of the present disclosure, an electrochemical device is provided which enables each of a plurality battery elements to be appropriately charged and thereby meet the demand for higher voltage even when said plurality of battery elements are connected in electrically series between a pair of electrodes. The foregoing and other objects will become apparent from the following description and accompanying drawings.

### BRIEF DESCRIPTION OF THE SEVERAL VIEWS OF THE DRAWING

FIG. 1 shows an outer perspective view of an electrochemical device in accordance with an embodiment of the present disclosure.

FIG. 2 shows a cross-sectional view of the electrochemical device shown in FIG. 1 along with line S11.

FIG. 3 shows a top view of the electrochemical device shown in FIG. 1 with the lid and battery elements removed.

FIG. 4 shows an equivalent circuit of the electrochemical device shown in FIG. 1.

FIG. 5 shows an outer perspective view of an electrochemical device in accordance with another embodiment of the present disclosure.

FIG. 6 shows a cross-sectional view of the electrochemical device shown in FIG. 5 along with line S21.

FIG. 7 shows a top view of the electrochemical device shown in FIG. 5 with the lid and battery elements removed.

FIG. 8 shows an equivalent circuit of the electrochemical device shown in FIG. 5.

FIG. 9 shows an outer perspective view of an electrochemical device in accordance with another embodiment of the present disclosure.

FIG. 10 shows a cross-sectional view of the electrochemical device shown in FIG. 9 along with line S31.

FIG. 11 shows a top view of the electrochemical device shown in FIG. 9 with the lid and battery elements removed.

FIG. 12 shows an equivalent circuit of the electrochemical device shown in FIG. 9.

FIG. 13 shows an outer perspective view of the electrochemical device in accordance with another embodiment of the present disclosure.

FIG. 14 shows a cross-sectional view of an electrochemical device shown in FIG. 13 along with line S41.

FIG. 15 shows a top view of the electrochemical device shown in FIG. 13 with the lid and battery elements removed.

FIG. 16 shows an equivalent circuit of the electrochemical device shown in FIG. 13.

### DETAILED DESCRIPTION

In the description that follows, like components have been given the same or similar reference numerals, regardless of whether they are shown in different embodiments. To illustrate embodiments of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

### FIRST EXAMPLE

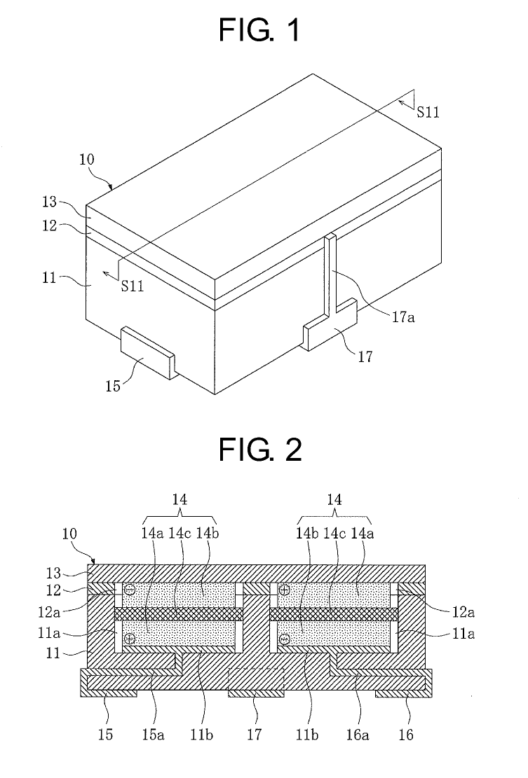

Referring now to FIGS. 1-4, one embodiment of the electrochemical device will be described in accordance with the present disclosure. As shown in FIG. 1, electrochemical device 10 in accordance with one embodiment of the present disclosure includes case 11, coupling plate 12, lid 13, a pair of chargeable and dischargeable battery elements 14, a pair of electrodes (positive electrode 15 and negative electrode 16), and intermediate electrode 17.

The case 11 may be made of any suitable insulator material such as alumina and formed into a cuboid shape. The lower surface of the case 11 may be used as a mount surface. A pair of concave portions 11a may be formed side by side on the upper surface of the case 11 with suitable depth. The pair of concave portions 11a may have a rectangular shape in top view. The bottom surface of each of the concave portions 11a is provided with current collector film 11b made of electrically conductive material such as aluminum. Each of the current collector films 11b may be formed to have a slightly smaller plane size than that of the bottom surface of the corresponding concave portions 11a.

In case the current collector films 11b may not be securely attached to the bottom surface of the concave portion 11a due, for example, to the material of the case 11, an auxiliary layer (e.g., a layer having a tungsten film, nickel film, and gold film laminated in that order from the bottom surface) (not shown) may be formed on each of the bottom surfaces of concave portions 11a in order to securely hold the current collector films 11b on to the bottom surface.

The coupling plate 12, made of any suitable electrically conductive material such as kovar, is formed into a rectangular shape in top view such that the shape of the coupling plate 12 in top view substantially conforms to that of the case 11. In one aspect, a pair of through-holes 12a may be formed in the coupling plate 12. The pair of through-holes 12a may be formed into the substantially same outline in top view as that of the concave portion 11a of the case 11. Since the coupling plate 12 is coupled to the upper surface of the case 11 via a bond such that each of the through-holes 12a aligns with the corresponding concave portion 11a, each of the through-holes 12a may constitute an upper part of each of the concave portions 11a.

In case the coupling plate 12 may not be securely attached to the upper surface of the case 11 via a bond such as gold-copper alloy due, for example, to the material of case 11, an auxiliary layer (e.g., a layer having a tungsten film and nickel film laminated in that order from upper surface) (not shown) may be formed on the upper surfaces of the case 11 in order to securely hold the coupling plate 12 onto the upper surface. In another aspect, a corrosion resistance film (e.g., a film having nickel film and gold film laminated in that order, wherein the gold film may be replaced with other types of metal films such as platinum film, silver film or palladium film) may be formed on the surface of the coupling plate 12 (at least on the upper and lower surfaces of the coupling plate 12 and the interior surface of the through-holes 12a) in order to improve corrosion resistance of the coupling plate 12 against electrolytic solutions, particularly when the coupling plate 12 is made of materials with relatively low corrosion resistance against electrolytic solutions.

The lid 13 may be made of an electrically conductive material such as kovar (iron-nickel-cobalt alloy). In some aspects, the lid 13 may be made of, for example, clad materials composed of a kovar base material having nickel films on at least one of its upper and lower surfaces. The nickel film may be replaced with other types of metal films such as platinum film, silver film, gold film, or palladium film. The lid 13 may be formed into a rectangular shape in top view which substantially conforms to the top-view shape of the case 11.

The lid 13 is coupled to the coupling plate 12 such that the lower surface of the lid 13 is electrically conductive to the upper surface of the coupling plate 12 and each of the concave portions 11a is sealed in a watertight and air tight manner after battery elements 14 are inserted into each of the concave portions 11a (which includes each of the through-holes 12a). In one aspect, the lid 13 may be coupled to the coupling plate 12 using any suitable direct joining techniques such as seam welding or laser welding as well as indirect joining techniques using any suitable conductive bonds.

Each of the battery elements 14 respectively includes a rectangular first electrode sheet 14a, a rectangular second electrode sheet 14b and a rectangular separate sheet 14c intervening between the first and second sheets 14a, 14b. In one aspect, the plane sizes of the first electrode sheet 14a and second electrode sheet 14b may be smaller than that of the concave portions 11a, and the plane size of the separate sheet 14c may be slightly larger than that of the first and second sheets 14a, 14b and slightly smaller than that of each of the concave portions 11a. The first electrode sheet 14a and the second electrode sheet 14b may be made of active materials such as activated carbon or PAS (polyacene-type semiconductor), and the separate sheet 14c may be made of an ion-permeable sheet such as glass sheet, cellulose sheet, and plastic sheet. The materials of the first electrode sheet 14a and second electrode sheet 14b may be same as or different from one another, depending on the type of electrochemical device 10.

Each of the battery elements 14 is enclosed into the sealed concave portions 11a together with an electrolytic solution (e.g., a solution comprising triethylmethylammonium tetrafluoroborate (solute) dissolved in propylene carbonate (solvent)). In case the polarities of the first electrode sheet 14a and the second electrode sheet 14b have not yet been determined when the electrochemical device 10 is used (i.e., in case the polarities of the first electrode sheet 14a and the second electrode sheet 14b may be determined at the point of use such that they have opposite polarities to one another), the insertion direction of the battery elements 14 into each of the concave portions 11a may be arbitrary.

On the other hand, if the polarities of the first electrode sheet 14a and the second electrode sheet 14b are predetermined before use, the insertion direction of the battery elements 14 into each of the concave portions 11a should be determined according to the predetermined polarities. For example, if the first electrode sheet 14a is determined as positive and the polarity of the second electrode sheet 14b is determined as negative, the battery elements 14 may be inserted into each of the concave portions 11a such that the first electrode sheet 14a of the battery element 14 shown on the left side of FIG. 2 is in electrical contact with the current collector films 11b shown on the left side of FIG. 2 and the second electrode sheet 14b of the same is in electrical contact with the lid 13; and the second electrode sheet 14b of the battery element 14 shown on the right side of of FIG. 2 is in electrical contact with the current collector film 11b shown on the right side of of FIG. 2 and the first electrode sheet 14a of the same is in electrical contact with the lid 13.

The positive electrode 15 may be made of electrically conductive material such as gold. The positive electrode 15 may be formed into a substantially L shape in cross section extending from the center of one side surface along the longitudinal direction to the lower surface of the case 11. As shown in FIG. 2, the positive electrode 15 is electrically connected to the current collector film 11b shown on the left side of FIG. 2 via wiring 15a (composed of electrically conductive material such as tungsten) formed through the case 11.

The negative electrode 16 may be made of electrically conductive material such as gold. The negative electrode 16 may be formed into a substantially L shape in cross section extending from the center of the other side surface along the longitudinal direction to the lower surface of the case 11. The negative electrode 16 may be formed to have a substantially same width as the positive electrode 15. As shown in FIG. 2, the negative electrode 16 is electrically connected to the current collector films 11b of the battery element 14 shown on the right side of of FIG. 2 via wiring 16a (composed of electrically conductive material such as tungsten) formed through the case 11.

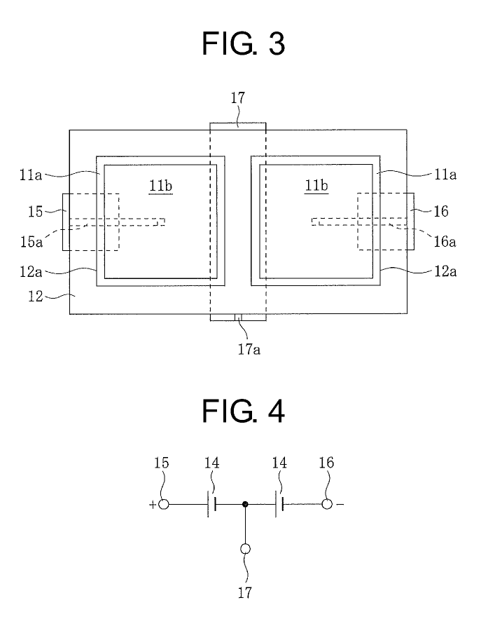

The intermediate electrode 17 may be made of electrically conductive material such as gold. The intermediate electrode 17 may be formed into a substantially reverse C shape in cross section extending from the center of one side surface along the width direction of the case 11 to the lower surface of the case 11. As shown in FIGS. 1 and 3, the intermediate electrode 17 is electrically connected to the lid 13 via wiring 17a (composed of electrically conductive material such as tungsten) formed on one side surface of the case 11.

In case the positive electrode 15, negative electrode 16 and intermediate electrode 17 may not be securely attached to the surface of the case 11 due, for example, to the material of the case 11, an auxiliary layer (e.g., a layer having a tungsten film and nickel film laminated in that order from the case 11) (not shown) may be formed on each surface of the case 11 in order to securely hold the positive electrode 15, negative electrode 16 and intermediate electrode 17 onto the case 11.

FIG. 4 shows an equivalent circuit of the electrochemical device 10 in accordance with one embodiment of the present disclosure. As shown, the equivalent circuit comprises a pair of battery elements 14 disposed between the positive electrode 15 and negative electrode 16. The pair of battery elements 14 are connected to one another in electrically series. The equivalent circuit also comprises intermediate electrode 17 electrically connected to the junction between the pair of battery elements 14. Accordingly, the battery element 14 shown on the left side of FIG. 4 may be charged by using the positive electrode 15 and the intermediate electrode 17 (serving a negative electrode). Similarly, the battery element 14 shown on the right side of FIG. 4 may be charged by using the negative electrode 16 and the intermediate electrode 17 (serving as a positive electrode). Thus, where the pair of battery elements 14 are disposed in electrically series between the positive electrode 15 and the negative electrode 16, charging of each of the battery elements 14 may be carried out independently of one another (i.e., charging may be carried out on an individual battery element basis). As such, despite variation in charge/discharge characteristic of each of the battery elements 14, it is possible to avoid the phenomenon as observed in the conventional art that some of the battery elements are fully charged but the remaining battery elements are insufficiently charged, and charging of each of the battery elements 14 may be carried out in accordance with the charge/discharge characteristic thereof. Consequently, the electrochemical device 10 may have a nominal voltage twice or nearly twice as high as that of the individual battery element 14, thereby meeting the recent demand for high voltage.

In addition, when the electrochemical device 10 is surface mounted on a circuit board, the above-described charging method may be carried out for the electrochemical device 10 mounted on the circuit board by simply forming on the circuit board a pad which may be connected to the positive electrode 15 for both charging and discharging, a pad which may be connected to the negative electrode 16 for both charging and discharging, and a pad which may be connected to the intermediate electrode 17 for charging. As such, the electrochemical device 10 is versatile in that the electrochemical device 10 may be applied to cell phones, laptop computers, video cameras, digital cameras, and other electronic devices suited for high-density packaging by being surface mounted in a similar manner to other electronic components for the electronic devices and may achieve the above-described individual charging.

Furthermore, the electrochemical device 10 may be configured such that the first electrode sheet 14a and the second electrode sheet 14b of one battery element 14 are electrically connected to the electrically conductive lid 13. As such, the lid 13 may be utilized as a part of wiring for electrically connecting the pair of the battery elements 14 in series between the positive electrode 15 and the negative electrode 16, thereby simplifying the entire wiring and thus preventing the device from getting larger due to complex wiring.

### SECOND EXAMPLE

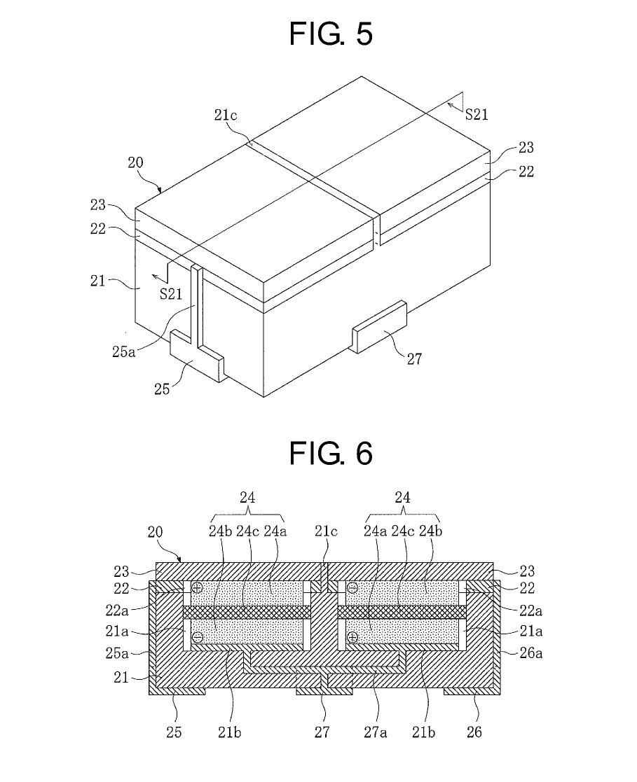

Referring now to FIGS. 5-8, another embodiment of the electrochemical device will be described in accordance with the present disclosure. As shown in FIG. 5, electrochemical device 20 in accordance with another embodiment of the present disclosure includes case 21, coupling plates 22, a pair of lid units 23, a pair of chargeable and dischargeable battery elements 24, a pair of electrodes (positive electrode 25 and negative electrode 26), and intermediate electrode 27.

The case 21 may be made of any suitable insulator material such as alumina and formed into a cuboid shape. The lower surface of the case 21 may be used as a mount surface. A pair of concave portions 21a may be formed side by side on the upper surface of the case 21 with suitable depth. The pair of concave portions 21a may have a rectangular shape in top view. The bottom surface of each of the concave portions 21a is provided with current collector films 21b made of electrically conductive material such as aluminum and formed to have a slightly smaller plane size than that of the bottom surface. In one aspect, plate 21c may be integrally formed on the portion of the upper surface of the case 21 located between the pair of concave portions 21a. The plate 21c may extend in the width direction of the case 21. The thickness of the plate 21 may be smaller than the width of the portion that is sandwiched in between the pair of concave portions 21a. The plate 21c may be made of the same material as the case 21. The height of the plate 21c may be substantially same as that of the lid 23. In another aspect, the plate 21c may be prepared separately from the case 21 and then attached to the case 21. The plate 21c may be made of the same material as or different material from the case 21. The plate 21c may be omitted if a sufficient space can be ensured between each of the coupling plates 22 as well as between the lid units 23 so as to avoid contacts therebetween.

In case the current collector films 21b may not be securely attached to the bottom surface of concave portion 21a due, for example, to the material of the case 21, an auxiliary layer (e.g., a layer having a tungsten film, nickel film, and gold film laminated in that order from the bottom surface) (not shown) may be formed on each of the bottom surfaces of concave portions 21a in order to securely hold the current collector films 21b on to the bottom surface.

Each of the coupling plates 22, made of any suitable electrically conductive material such as kovar, is formed into a rectangular shape in top view such that the length of each of the coupling plates 22 in top view is slightly smaller than the half of that of the case 21. In one aspect, a pair of through-holes 22a may be formed in each of the coupling plates 22. The pair of through-holes 22a may be formed into the substantially same outline in top view as that of the concave portion 21a of the case 21. Since each of the coupling plates 22 is coupled to the upper surface of the case 21 via a bond such that each of the through-holes 22a aligns with the corresponding concave portion 21a. It should be noted that each of the through-holes 22a may constitute an upper part of each of the concave portions 21a. It should also be noted that the pair of the coupling plates 22 are not in contact with one another due to the existence of the insulating plate 21c disposed therebetween.

In case the coupling plates 22 may not be securely attached to the upper surface of the case 21 via a bond such as gold-copper alloy due, for example, to the material of case 21, an auxiliary layer (e.g., a layer having a tungsten film and nickel film laminated in that order from upper surface) (not shown) may be formed on the upper surfaces of the case 21 in order to securely hold the coupling plates 22 onto the upper surface. In another aspect, a corrosion resistance film (e.g., a film having nickel film and gold film laminated in that order, wherein the gold film may be replaced with other types of metal films such as platinum film, silver film or palladium film) may be formed on the surface of the coupling plates 22 (at least on the upper and lower surfaces of each of the coupling plates 22 and the interior surface of the through-holes 22a) in order to improve corrosion resistance of the coupling plates 22 against electrolytic solutions, particularly when the coupling plates 22 are made of materials with relatively low corrosion resistance against electrolytic solutions.

The lid units 23 may be made of an electrically conductive material such as kovar (iron-nickel-cobalt alloy). In some aspects, the lid units 23 may be made of, for example, clad materials composed of a kovar base material having nickel films on at least one of its upper and lower surfaces. The nickel film may be replaced with other types of metal films such as platinum film, silver film, gold film, or palladium film. Each of the lid units 23 may be formed into a rectangular shape in top view so as to substantially conform to the outline of each of the coupling plates 22.

Each of the lid units 23 is coupled to the corresponding coupling plates 22 such that each of the lower surfaces of the lid units 23 is electrically conductive to the upper surface of the corresponding coupling plates 22 and each of the concave portions 21a is sealed in a watertight and air tight manner after the battery elements 24 are inserted into the corresponding concave portions 21a (which includes each of the through-holes 22a). In one aspect, the lid units 23 may be coupled to the coupling plates 22 using any suitable direct joining techniques such as seam welding or laser welding as well as indirect joining techniques using any suitable conductive bonds. It should be noted that the lid units 23 are not in contact with one another due to the existence of the insulating plate 21c disposed therebetween.

Each of the battery elements 24 includes a rectangular first electrode sheet 24a, a rectangular second electrode sheet 24b and a rectangular separate sheet 24c intervening between the first and second sheets 24a, 24b. In one aspect, each of the plane sizes of the first electrode sheet 24a and second electrode sheet 24b may be smaller than that of the corresponding concave portion 21a, and the plane size of the separate sheet 24c may be slightly larger than that of the corresponding first and second sheets 24a, 24b and slightly smaller than that of the corresponding concave portion 21a. The first electrode sheet 24a and the second electrode sheet 24b may be made of active materials such as activated carbon or PAS (polyacene-type semiconductor), and the separate sheet 24c may be made of an ion-permeable sheet such as glass sheet, cellulose sheet, and plastic sheet. The materials of the first electrode sheet 24a and second electrode sheet 24b may be same as or different from one another, depending on the type of electrochemical device 20.

Each of the battery elements 24 is enclosed into the sealed concave portions 21a together with an electrolytic solution (e.g., a solution comprising triethylmethylammonium tetrafluoroborate (solute) dissolved in propylene carbonate (solvent)). In case the polarities of the first electrode sheet 24a and the second electrode sheet 24b have not yet been determined when the electrochemical device 20 is used (i.e., in case the polarities of the first electrode sheet 24a and the second electrode sheet 24b may be determined at the point of use such that they have opposite polarities to one another), the insertion direction of the battery elements 24 into each of the concave portions 21a may be arbitrary.

On the other hand, if the polarities of the first electrode sheet 24a and the second electrode sheet 24b are predetermined before use, the insertion direction of the battery elements 24 into each of the concave portions 21a should be determined according to the predetermined polarities. For example, if the first electrode sheet 24a is determined as positive and the polarity of the second electrode sheet 24b is determined as negative, the battery elements 24 may be inserted into each of the concave portions 21a such that the first electrode sheet 24a of the battery element 24 shown on the left side of FIG. 6 is in electrical contact with the lid unit 23 shown on the left side of FIG. 6 and the second electrode sheet 24b is in electrical contact with the current collector film 21b shown on the left side of FIG. 6; and the first electrode sheet 24a of the battery element 24 shown on the right side of of FIG. 6 is in electrical contact with the current collector film 21b of the battery element 24 shown on the right side of of FIG. 6 and the second electrode sheet 24b is in electrical contact with the lid unit 23 shown on the right side of FIG. 6.

The positive electrode 25 may be made of electrically conductive material such as gold. The positive electrode 25 may be formed into a substantially L shape in cross section extending from the center of one side surface along the longitudinal direction to the lower surface of the case 21. As shown in FIGS. 5-7, the positive electrode 25 is electrically connected to the lid 23 shown on the left side of FIG. 6 via wiring 25a (composed of electrically conductive material such as tungsten) formed on the side surface of the case 21 and via the coupling plates 22 also shown on the left side of FIG. 6.

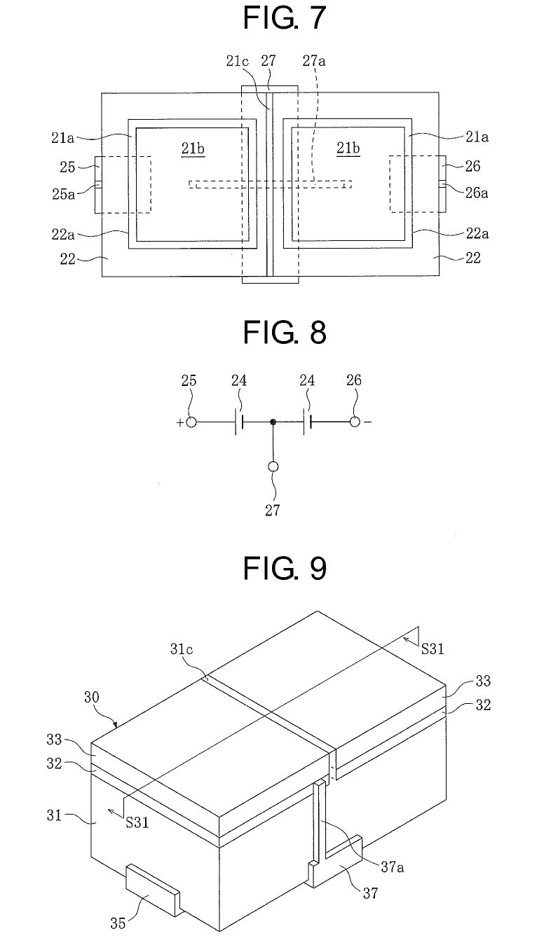

The negative electrode 26 may be made of electrically conductive material such as gold. The negative electrode 26 may be formed into a substantially L shape in cross section extending from the center of the other side surface along the longitudinal direction to the lower surface of the case 21. The negative electrode 26 may be formed to have a substantially same width as the positive electrode 25. As shown in FIGS. 6 and 7, the negative electrode 26 is electrically connected to the lid unit 23 shown on the right side of FIG. 6 via wiring 26a (composed of electrically conductive material such as tungsten) formed on the side surface of the case 21 and the coupling plates 22 also shown on the right side of FIG. 6.

The intermediate electrode 27 may be made of electrically conductive material such as gold. The intermediate electrode 27 may be formed into a substantially reverse C shape in cross section extending from the center of one side surface along the width direction of the case 21 to the lower surface of the case 21. As shown in FIG. 6, the intermediate electrode 27 is electrically connected to the both current collector films 21b via wiring 27a (composed of electrically conductive material such as tungsten) formed through the case 21.

In case the positive electrode 25, negative electrode 26 and intermediate electrode 27 may not be securely attached to the surface of the case 21 due, for example, to the material of the case 21, an auxiliary layer (e.g., a layer having a tungsten film and nickel film laminated in that order from the case 21) (not shown) may be formed on each surface of the case 21 in order to securely hold the positive electrode 25, negative electrode 26 and intermediate electrode 27 onto the case 21.

FIG. 8 shows an equivalent circuit of the electrochemical device 20 in accordance with one embodiment of the present disclosure. As shown, the equivalent circuit comprises a pair of battery elements 24 disposed between the positive electrode 25 and negative electrode 26. The pair of battery elements 24 are connected to one another in electrically series. The equivalent circuit also comprises intermediate electrode 27 electrically connected to the junction between the pair of battery elements 24. Accordingly, the battery element 24 shown on the left side of FIG. 8 may be charged by using the positive electrode 25 and the intermediate electrode 27 (serving a negative electrode). Similarly, the battery elements 24 shown on the right side of FIG. 8 may be charged by using the negative electrode 26 and the intermediate electrode 27 (serving as a positive electrode). Thus, where the pair of battery elements 24 are disposed in electrically series between the positive electrode 25 and the negative electrode 26, charging of each of the series-connected battery elements 24 may be carried out independently of one another (i.e., charging may be carried out on an individual battery element basis). As such, despite variation in charge/discharge characteristic of each of the battery elements 24, it is possible to avoid the phenomenon as observed in the conventional art that some of the battery elements are fully charged but the remaining battery elements are insufficiently charged, and charging of each of the battery elements 24 may be carried out in accordance with the charge/discharge characteristic thereof. Consequently, the electrochemical device 20 may have a nominal voltage twice or nearly twice as high as that of the individual battery element 24, thereby meeting the recent demand for high voltage.

In addition, when the electrochemical device 20 is surface mounted on a circuit board, the above-described charging method may be carried out for the electrochemical device 20 mounted on the circuit board by simply forming on the circuit board a pad which may be connected to the positive electrode 25 for both charging and discharging, a pad which may be connected to the negative electrode 26 for both charging and discharging, and a pad which may be connected to the intermediate electrode 27 for charging. As such, the electrochemical device 20 is versatile in that the electrochemical device 20 may be applied to cell phones, laptop computers, video cameras, digital cameras, and other electronic devices suited for high-density packaging by being surface mounted in a similar manner to other electronic components for the electronic devices and may achieve the above-described individual charging.

Furthermore, the electrochemical device 20 may be configured such that the first electrode sheet 24a of one of the battery elements 24 is electrically connected to one of the lid units 23 and the second electrode sheet 24b of the other of the battery elements 24 is electrically connected to the other of the lid units 23. As such, the pair of lid units 23 may be utilized as a part of wiring for electrically connecting the pair of the battery elements 24 in series between the positive electrode 25 and the negative electrode 26, thereby simplifying the entire wiring and, thus, preventing the device from getting larger due to complex wiring.

Furthermore, the electrochemical device 20 may be configured such that the insulating plate 21c intervenes between each of the coupling plates 22 as well as each of the lid units 23, thereby preventing the coupling plates 22 from being in contact with one another, and also preventing the lid units 23 from being in contact with one another. In addition, the plate 21c may facilitate the alignment between the coupling plates 22 and the upper surface of the case 21 and the alignment between the lid units 23 and the upper surface of the coupling plates 22.

### THIRD EXAMPLE

Referring now to FIGS. 9-12, another embodiment of the electrochemical device will be described in accordance with the present disclosure. As shown in FIG. 9, electrochemical device 30 in accordance with another embodiment of the present disclosure includes case 31, a pair of coupling plates 32, a pair of lid units 33, a pair of chargeable and dischargeable battery elements 34, a pair of electrodes (positive electrode 35 and negative electrode 36), and intermediate electrode 37.

The case 31 may be made of any suitable insulator material such as alumina and formed into a cuboid shape. The lower surface of the case 31 may be used as a mount surface. A pair of concave portions 31a may be formed side by side on the upper surface of the case 31 with suitable depth. Each of the pair of concave portions 31a may have a rectangular shape in top view. The bottom surface of each of the concave portions 31a is provided with current collector film 31b made of electrically conductive material such as aluminum and formed to have a slightly smaller plane size than that of the bottom surface of each of the concave portions 31a. In one aspect, plate 31c may be integrally formed on the portion of the upper surface of the case 31 located between the pair of concave portions 31a. The plate 31c may extend in the width direction of the case 31. The thickness of the plate 31 may be smaller than the width of the portion that is sandwiched in between the pair of concave portions 31a. The plate 31c may be made of the same material as the case 31. The height of the plate 31c may be substantially same as that of the lid 33. The plate 31c may be prepared separately from the case 31 and then attached to the case 31. The plate 31c may be made of the same material as or different material from the case 31. The plate 31c may be omitted if a sufficient space can be ensured between each of the coupling plates 32 as well as between the lid units 33 so as to avoid contacts therebetween.

In case the current collector films 31b may not be securely attached to the bottom surface of the concave portion 31a due, for example, to the material of the case 31, an auxiliary layer (e.g., a layer having a tungsten film, nickel film, and gold film laminated in that order from the bottom surface) (not shown) may be formed on each of the bottom surfaces of concave portions 31a in order to securely hold the current collector films 31b on to the bottom surface.

Each of the coupling plates 32, made of any suitable electrically conductive material such as kovar, is formed into a rectangular shape in top view such that the length of each of the coupling plates 32 in top view is slightly smaller than half of that of the case 31. In one aspect, a pair of through-holes 32a may be formed on each of the coupling plates 32. The pair of through-holes 32a may be formed into the substantially same outline in top view as that of the corresponding concave portion 31a. Since the coupling plates 32 are coupled to the upper surface of the case 31 via a bond such that each of the through-holes 32a aligns with the corresponding concave portion 31a, each of the through-holes 32a may constitute an upper part of the corresponding concave portions 31a. It should be noted that the pair of the coupling plates 32 are not in contact with one another due to the existence of the insulating plate 31c disposed therebetween.

In case the coupling plates 32 may not be securely attached to the upper surface of the case 31 via a bond such as gold-copper alloy due, for example, to the material of case 31, an auxiliary layer (e.g., a layer having a tungsten film and nickel film laminated in that order from upper surface) (not shown) may be formed on the upper surfaces of the case 31 in order to securely hold the coupling plates 32 onto the upper surface. In another aspect, a corrosion resistance film (e.g., a film having nickel film and gold film laminated in that order, wherein the gold film may be replaced with other types of metal films such as platinum film, silver film or palladium film) may be formed on the surface of the coupling plates 32 (at least on the upper and lower surfaces of each of the coupling plates 32 and the interior surface of the through-holes 32a) in order to improve corrosion resistance of the coupling plates 32 against electrolytic solutions, particularly when the coupling plates 32 is made of materials with relatively low corrosion resistance against electrolytic solutions.

The lid units 33 may be made of an electrically conductive material such as kovar (iron-nickel-cobalt alloy). In some aspects, the lid units 33 may be made of, for example, clad materials composed of a kovar base material having nickel films on at least one of its upper and lower surfaces. The nickel film may be replaced with other types of metal films such as platinum film, silver film, gold film, or palladium film. Each of the lid units 33 may be formed into a rectangular shape in top view so as to substantially conform to that of each of the coupling plates 32.

Each of the lid units 33 is coupled to the corresponding coupling plate 32 such that each of the lower surfaces of the lid units 33 is electrically conductive to the upper surface of the corresponding coupling plate 32 and each of the concave portions 31a is sealed in a watertight and air tight manner after the battery elements 34 are inserted into each of the concave portions 31a (which includes each of the through-holes 32a). In one aspect, the lid units 33 may be coupled to the coupling plates 32 using any suitable direct joining techniques such as seam welding or laser welding as well as indirect joining techniques using any suitable conductive bonds. It should be noted that the lid units 33 are not in contact with one another due to the existence of the insulating plate 31c disposed therebetween.

Each of the battery elements 34 includes a rectangular first electrode sheet 34a, a rectangular second electrode sheet 34b and a rectangular separate sheet 34c intervening between the first and second sheets 34a, 34b. In one aspect, the plane sizes of the first electrode sheet 34a and second electrode sheet 34b may be smaller than that of the corresponding concave portion 31a, and the plane size of the separate sheet 34c may be slightly larger than that of the corresponding first and second sheets 34a, 34b and slightly smaller than that of the corresponding concave portion 31a. The first electrode sheet 34a and the second electrode sheet 34b may be made of active materials such as activated carbon or PAS (polyacene-type semiconductor), and the separate sheet 34c may be made of an ion-permeable sheet such as glass sheet, cellulose sheet, and plastic sheet. The materials of the first electrode sheet 34a and second electrode sheet 34b may be same as or different from one another, depending on the type of electrochemical device 30.

Each of the battery elements 34 is enclosed into the corresponding sealed concave portion 31a together with an electrolytic solution (e.g., a solution comprising triethylmethylammonium tetrafluoroborate (solute) dissolved in propylene carbonate (solvent)). In case the polarities of the first electrode sheet 34a and the second electrode sheet 34b have not yet been determined when the electrochemical device 30 is used (i.e., in case the polarities of the first electrode sheet 34a and the second electrode sheet 34b may be determined at the point of use such that they have opposite polarities to one another), the insertion direction of the battery elements 34 into the corresponding concave portion 31a may be arbitrary.

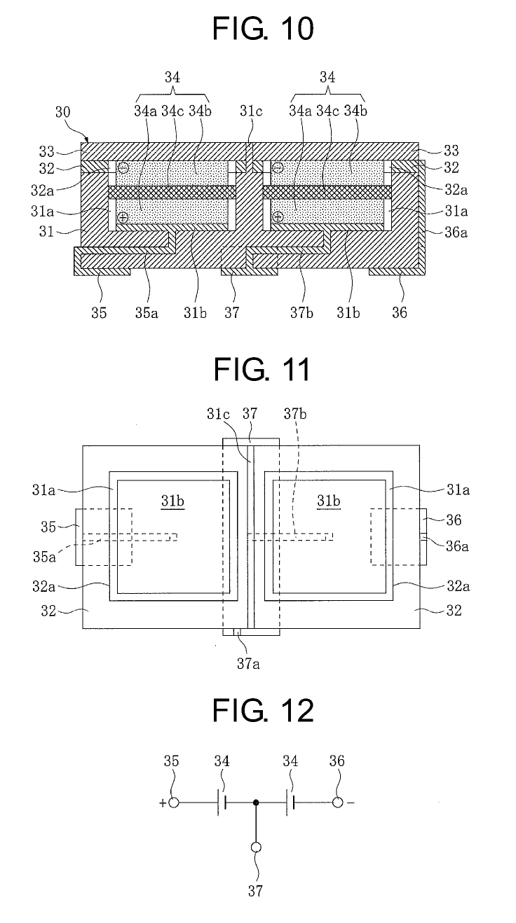

On the other hand, if the polarities of the first electrode sheet 34a and the second electrode sheet 34b are predetermined before use, the insertion direction of each of the battery elements 34 into the corresponding concave portion 31a should be determined according to the predetermined polarities. For example, if the first electrode sheet 34a is determined as positive and the polarity of the second electrode sheet 34b is determined as negative, each of the battery elements 34 may be inserted into the corresponding concave portion 31a such that the first electrode sheet 34a of the battery element 34 shown on the left side of FIG. 10 is in electrical contact with the current collector film 31b shown on the left side of FIG. 10 and the second electrode sheet 34b is in electrical contact with the lid unit 33 shown on the left side of FIG. 10; and the first electrode sheet 34a of the battery element 34 shown on the right side of of FIG. 10 is in electrical contact with the current collector film 31b shown on the right side of FIG. 10 and the second electrode sheet 34b is in electrical contact with the lid unit 33 shown on the right side of FIG. 10.

The positive electrode 35 may be made of electrically conductive material such as gold. The positive electrode 35 may be formed into a substantially L shape in cross section extending from the center of one side surface along the longitudinal direction to the lower surface of the case 31. As shown in FIG. 10, the positive electrode 35 is electrically connected to the current collector film 31b shown on the left side of FIG. 10 via wiring 35a (composed of electrically conductive material such as tungsten) formed through the case 31.

The negative electrode 36 may be made of electrically conductive material such as gold. The negative electrode 36 may be formed into a substantially L shape in cross section extending from the center of the other side surface along the longitudinal direction to the lower surface of the case 31. The negative electrode 36 may be formed to have a substantially same width as the positive electrode 35. As shown in FIGS. 10 and 11, the negative electrode 36 is electrically connected to the lid unit 33 shown on the right side of FIG. 10 via wiring 36a (composed of electrically conductive material such as tungsten) formed on the side surface of the case 31 and the coupling plates 32 shown on the right side of FIG. 10.

The intermediate electrode 37 may be made of electrically conductive material such as gold. The intermediate electrode 37 may be formed into a substantially reverse C shape in cross section extending from the center of one side surface along the width direction of the case 31 to the lower surface of the case 31. As shown in FIGS. 9-11, the intermediate electrode 37 is electrically connected to the lid unit 33 shown on the left side of FIG. 10 via wiring 37a (composed of electrically conductive material such as tungsten) formed on the side surface of the case 31 and via the coupling plates 32 shown on the left side of FIG. 10. In addition, the intermediate electrode 37 is electrically connected to the current collector film 31b of the battery element 34 shown on the right side of of FIG. 10 via wiring 37b (composed of electrically conductive material such as tungsten) formed through the case 31.

In case the positive electrode 35, negative electrode 36 and intermediate electrode 37 may not be securely attached to the surface of the case 31 due, for example, to the material of the case 31, an auxiliary layer (e.g., a layer having a tungsten film and nickel film laminated in that order from the case 31) (not shown) may be formed on each surface of the case 31 in order to securely hold the positive electrode 35, negative electrode 36 and intermediate electrode 37 onto the case 31.

FIG. 12 shows an equivalent circuit of the electrochemical device 30 in accordance with one embodiment of the present disclosure. As shown, the equivalent circuit comprises a pair of battery elements 34 disposed between the positive electrode 35 and negative electrode 36. The pair of battery elements 34 are connected to one another in electrically series. The equivalent circuit also comprises intermediate electrode 37 electrically connected to the junction between the pair of battery elements 34. Accordingly, the battery element 34 shown on the left side of FIG. 12 may be charged by using the positive electrode 35 and the intermediate electrode 37 (serving a negative electrode). Similarly, the battery elements 34 shown on the right side of FIG. 12 may be charged by using the negative electrode 36 and the intermediate electrode 37 (serving as a positive electrode). Thus, where the pair of battery elements 34 are disposed in electrically series between the positive electrode 35 and the negative electrode 36, charging of each of the battery elements 34 may be carried out independently of one another (i.e., charging may be carried out on an individual battery element basis). As such, despite variation in charge/discharge characteristic of each of the battery elements 34, it is possible to avoid the phenomenon as observed in the conventional art that some of the battery elements are fully charged but the remaining battery elements are insufficiently charged, and charging of each of the battery elements 34 may be carried out in accordance with the charge/discharge characteristic thereof. Consequently, the electrochemical device 30 may have a nominal voltage twice or nearly twice as high as that of the individual battery element 34, thereby meeting the recent demand for high voltage.

In addition, when the electrochemical device 30 is surface mounted on a circuit board, the above-described charging method may be carried out for the electrochemical device 30 mounted on the circuit board by simply forming on the circuit board a pad which may be connected to the positive electrode 35 for both charging and discharging, a pad which may be connected to the negative electrode 36 for both charging and discharging, and a pad which may be connected to the intermediate electrode 37 for charging. As such, the electrochemical device 30 is versatile in that the electrochemical device 30 may be applied to cell phones, laptop computers, video cameras, digital cameras, and other electronic devices suited for high-density packaging by being surface mounted in a similar manner to other electronic components for the electronic devices and may achieve the above-described individual charging.

Furthermore, the electrochemical device 30 may be configured such that the first electrode sheet 34a of one of the battery elements 34 is electrically connected to one of the lid units 33 and the second electrode sheet 34b of the other battery element 34 is electrically connected to the other of the lid units 33. As such, the pair of lid units 33 may be utilized as a part of wiring for electrically connecting the pair of the battery elements 34 in series between the positive electrode 35 and the negative electrode 36, thereby simplifying the entire wiring and thus preventing the device from getting larger due to complex wiring.

Furthermore, the electrochemical device 30 may be configured such that the insulating plate 31c intervenes between the coupling plates 32 as well as the lid units 33, thereby preventing the coupling plates 32 from being in contact with one another, and also preventing the lid units 33 from being in contact with one another. In addition, the plate 31c may facilitate the alignment between the coupling plates 32 and the upper surface of the case 31 as well as the alignment between the lid units 33 and the upper surface of the coupling plates 32.

### FOURTH EXAMPLE

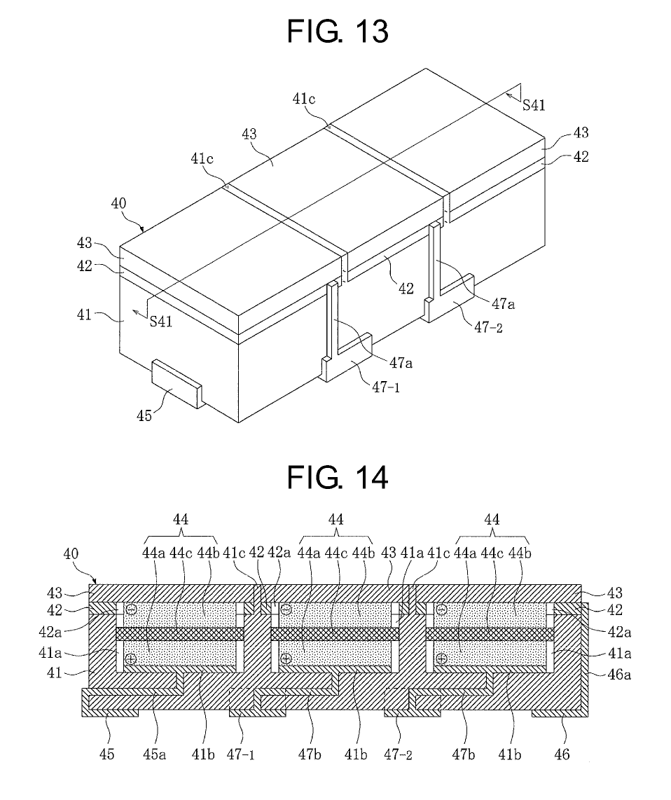

Referring now to FIGS. 13-16, another embodiment of the electrochemical device will be described in accordance with the present disclosure. As shown in FIG. 13, electrochemical device 40 in accordance with another embodiment of the present disclosure includes case 41, three coupling plates 42, three lid units 43, three chargeable and dischargeable battery elements 44, a pair of electrodes (positive electrode 45 and negative electrode 46), and intermediate electrodes 47-1 and 47-2.

The case 41 may be made of any suitable insulator material such as alumina and formed into a cuboid shape. The lower surface of the case 41 may be used as a mount surface. Three concave portions 41a may be formed side by side on the upper surface of the case 41 with suitable depth. Each of the concave portions 41a may have a rectangular shape in top view. The bottom surface of each of the concave portions 41a is provided with corresponding current collector film 41b made of electrically conductive material such as aluminum and formed to have a slightly smaller plane size than that of the bottom surface. In one aspect, plates 41c may be integrally formed on each of the two portions of the upper surface of the case 41 each located between the adjacent concave portions 41a. The plates 41c may extend in the width direction of the case 41. The thickness of each of the plates 41c may be smaller than the width of the portion that is sandwiched in between the adjacent concave portions 41a. The plates 41c may be made of the same material as the case 41. The height of each of the plates 41c may be substantially same as that of the lid 43. The plates 41c may be prepared separately from the case 41 and then attached to the case 41. The plates 41c may be made of the same material as or different material from the case 41. The plates 41c may be omitted if a sufficient space can be ensured between the coupling plates 42 as well as between the lid units 43 so as to avoid contacts therebetween.

In case the current collector films 41b may not be securely attached to the bottom surface of concave portion 41a due, for example, to the material of the case 41, an auxiliary layer (e.g., a layer having a tungsten film, nickel film, and gold film laminated in that order from the bottom surface) (not shown) may be formed on each of the bottom surfaces of concave portions 41a in order to securely hold the current collector films 41b on to the bottom surface.

Each of the coupling plates 42, made of any suitable electrically conductive material such as kovar, is formed into a rectangular shape in top view such that the length of each of the coupling plates 42 in top view is slightly smaller than one third of that of the case 41. In one aspect, a pair of through-holes 42a may be formed in each of the coupling plates 42 respectively. The pair of through-holes 42a may be formed into the substantially same outline in top view as that of the corresponding concave portion 41a. Since the coupling plates 42 are coupled to the upper surface of the case 41 via a bond such that each of the through-holes 42a aligns with the corresponding concave portion 41a, each of the through-holes 42a may constitute an upper part of each of the concave portions 41a. It should be noted that the coupling plates 42 are not in contact with one another due to the existence of the insulating plates 41c disposed therebetween.

In case the coupling plates 42 may not be securely attached to the upper surface of the case 41 via a bond such as gold-copper alloy due, for example, to the material of case 41, an auxiliary layer (e.g., a layer having a tungsten film and nickel film laminated in that order from upper surface) (not shown) may be formed on the upper surfaces of the case 41 in order to securely hold the coupling plates 42 onto the upper surface. In another aspect, a corrosion resistance film (e.g., a film having nickel film and gold film laminated in that order, wherein the gold film may be replaced with other types of metal films such as platinum film, silver film or palladium film) may be formed on the surface of the coupling plates 42 (at least on the upper and lower surfaces of each of the coupling plates 42 and the interior surface of the through-holes 42a) in order to improve corrosion resistance of the coupling plates 42 against electrolytic solutions, particularly when the coupling plates 42 are made of materials with relatively low corrosion resistance against electrolytic solutions.

The lid units 43 may be made of an electrically conductive material such as kovar (iron-nickel-cobalt alloy). In some aspects, the lid units 43 may be made of, for example, clad materials composed of a kovar base material having nickel films on at least one of its upper and lower surfaces. The nickel film may be replaced with other types of metal films such as platinum film, silver film, gold film, or palladium film. Each of the lid units 43 may be formed into a rectangular shape in top view so as to substantially conform to that of the corresponding coupling plate 42.

Each of the lid units 43 is coupled to the corresponding coupling plate 42 such that each of the lower surfaces of the lid units 43 is electrically conductive to the upper surface of the corresponding coupling plates 42 and each of the concave portions 41a is sealed in a watertight and air tight manner after each of the battery elements 44 is inserted into the corresponding concave portions 41a (which includes each of the through-holes 42a). In one aspect, each of the lid units 43 may be coupled to the corresponding coupling plates 42 using any suitable direct joining techniques such as seam welding or laser welding as well as indirect joining techniques using any suitable conductive bonds. It should be noted that the lid units 43 are not in contact with one another due to the existence of the insulating plates 41c disposed therebetween.

Each of the battery elements 44 includes a rectangular first electrode sheet 44a, a rectangular second electrode sheet 44b and a rectangular separate sheet 44c intervening between the first and second sheets 44a, 44b. In one aspect, the plane sizes of the first electrode sheet 44a and second electrode sheet 44b may be smaller than that of the corresponding concave portions 41a, and the plane size of the separate sheet 44c may be slightly larger than that of the corresponding first and second sheets 44a, 44b and slightly smaller than that of the corresponding concave portions 41a. The first electrode sheet 44a and the second electrode sheet 44b may be made of active materials such as activated carbon or PAS (polyacene-type semiconductor), and the separate sheet 44c may be made of an ion-permeable sheet such as glass sheet, cellulose sheet, and plastic sheet. The materials of the first electrode sheet 44a and second electrode sheet 44b may be same as or different from one another, depending on the type of electrochemical device 40.

Each of the battery elements 44 is enclosed into the sealed concave portions 41a together with an electrolytic solution (e.g., a solution comprising triethylmethylammonium tetrafluoroborate (solute) dissolved in propylene carbonate (solvent)). In case the polarities of the first electrode sheet 44a and the second electrode sheet 44b have not yet been determined when the electrochemical device 40 is used (i.e., in case the polarities of the first electrode sheet 44a and the second electrode sheet 44b may be determined at the point of use such that they have opposite polarities to one another), the insertion direction of each of the battery elements 44 into the corresponding concave portions 41a may be arbitrary.

On the other hand, if the polarities of the first electrode sheet 44a and the second electrode sheet 44b are predetermined before use, the insertion direction of each of the battery elements 44 into the corresponding concave portions 41a should be determined according to the predetermined polarities. For example, if the first electrode sheet 44a is determined as positive and the polarity of the second electrode sheet 44b is determined as negative, each of the battery elements 44 should be inserted into the corresponding concave portions 41a such that the first electrode sheet 44a of the battery 44 shown on the left side of FIG. 14 is in electrical contact with the current collector films 41b shown on the left side of FIG. 14 and the second electrode sheet 44b of the same is in electrical contact with the lid unit 43 shown on the left side of FIG. 14; the first electrode sheet 44a of the battery 44 shown on the middle of FIG. 14 is in electrical contact with the current collector film 41b shown on the middle of FIG. 14 and the second electrode sheet 44b of the same is in electrical contact with the lid unit 43 shown on the middle of FIG. 14; and the first electrode sheet 44a of the battery 44 shown on the right side of FIG. 14 is in electrical contact with the current collector films 41b shown on the right side of of FIG. 14 and the second electrode sheet 44b of the battery 44 shown on the right side of FIG. 14 is in electrical contact with the lid unit 43 shown on the right side of FIG. 14

The positive electrode 45 may be made of electrically conductive material such as gold. The positive electrode 45 may be formed into a substantially L shape in cross section extending from the center of one side surface along the longitudinal direction to the lower surface of the case 41. As shown in FIG. 14, the positive electrode 45 is electrically connected to the current collector film 41b shown on the left side of FIG. 10 via wiring 45a (composed of electrically conductive material such as tungsten) formed through the case 41.

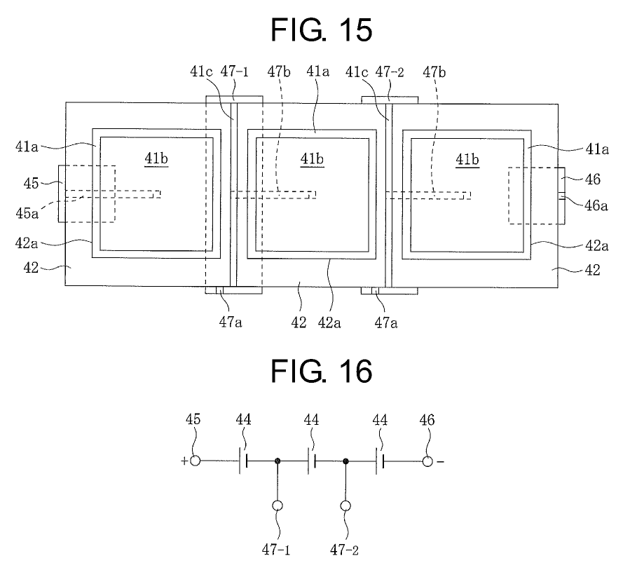

The negative electrode 46 may be made of electrically conductive material such as gold. The negative electrode 46 may be formed into a substantially L shape in cross section extending from the center of the other side surface along the longitudinal direction to the lower surface of the case 41. The negative electrode 46 may be formed to have a substantially same width as the positive electrode 45. As shown in FIGS. 14 and 15, the negative electrode 46 is electrically connected to the coupling plate 42 shown on the right side of FIG. 14 via wiring 46a (composed of electrically conductive material such as tungsten) formed on the side surface of the case 41.

The intermediate electrodes 47-1 and 47-2 may be made of electrically conductive material such as gold and formed into a substantially reverse C shape in cross section. The intermediate electrodes 47-1 and 47-2 may be formed on one the case 41 space apart from one another. Each of the intermediate electrodes 47-1 and 47-2 may extend from the center of one side surface along the lower surface to the other side surface of the case 41. As shown in FIGS. 13-15, the intermediate electrode 47-1 is electrically connected to the coupling plate 42 shown on the left side of FIG. 14 via wiring 47a (composed of electrically conductive material such as tungsten) formed on the side surface of the case 41 and also in electrically contact to the current collector film 41b shown on the middle of FIG. 14 via wiring 47b (composed of electrically conductive material such as tungsten) formed through the case 41. The intermediate electrode 47-2 is electrically connected to the coupling plate 42 shown on the middle of FIG. 14 via wiring 47a (composed of electrically conductive material such as tungsten) formed on the side surface of the case 41 and also in electrically contact to the current collector film 41b of the battery element 44 shown on the right side of of FIG. 14 via wiring 47b (composed of electrically conductive material such as tungsten) formed through the case 41.

In case the positive electrode 45, negative electrode 46 and intermediate electrodes 47-1 and 47-2 may not be securely attached to the surface of the case 41 due, for example, to the material of the case 41, an auxiliary layer (e.g., a layer having a tungsten film and nickel film laminated in that order from the case 41) (not shown) may be formed on each surface of the case 41 in order to securely hold the positive electrode 45, negative electrode 46 and intermediate electrodes 47-1 and 47-2 onto the case 41.

FIG. 16 shows an equivalent circuit of the electrochemical device 40 in accordance with one embodiment of the present disclosure. As shown, the equivalent circuit comprises three battery elements 44 disposed between the positive electrode 45 and negative electrode 46. The battery elements 44 are connected to one another in electrically series. The equivalent circuit also comprises intermediate electrodes 47-1 and 47-2 each of which is electrically connected to the corresponding junction between the adjacent battery elements 44. Accordingly, the battery element 44 shown on the left side of FIG. 16 may be charged by using the positive electrode 45 and the intermediate electrodes 47-1 (serving a negative electrode). Similarly, the battery element 44 shown on the middle of FIG. 16 may be charged by using the intermediate electrodes 47-1 (serving a positive electrode) and 47-2 (serving a negative electrode). Similarly, the battery element 44 shown on the right side of FIG. 16 may be charged by using the negative electrode 46 and the intermediate electrodes 47-2 (serving as a positive electrode). Thus, where three battery elements 44 are disposed in electrically series between the positive electrode 45 and the negative electrode 46, charging of each of the battery elements 44 may be carried out independently of one another (i.e., charging may be carried out on an individual battery element basis). As such, despite variation in charge/discharge characteristic of each of the battery elements 44, it is possible to avoid the phenomenon as observed in the conventional art that some of the battery elements are fully charged but the remaining battery elements are insufficiently charged, and charging of each of the battery elements 44 may be carried out in accordance with the charge/discharge characteristic thereof. Consequently, the electrochemical device 40 may have a nominal voltage three times or nearly three times higher than that of the individual battery element 44, thereby meeting the recent demand for high voltage.

In addition, when the electrochemical device 40 is surface mounted on a circuit board, the above-described charging method may be carried out for the electrochemical device 40 mounted on the circuit board by simply forming on the circuit board a pad which may be connected to the positive electrode 45 for both charging and discharging, a pad which may be connected to the negative electrode 46 for both charging and discharging, and a pad which may be connected to the intermediate electrodes 47-1 and 47-2 for charging. As such, the electrochemical device 40 is versatile in that the electrochemical device 40 may be applied to cell phones, laptop computers, video cameras, digital cameras, and other electronic devices suited for high-density packaging by being surface mounted in a similar manner to other electronic components for the electronic devices and may achieve the above-described individual charging.

Furthermore, the electrochemical device 40 may be configured such that the second electrode sheet 44b of one of the battery elements 44 is electrically connected to one of the lid units 43, the second electrode sheet 44b of one of the other of the battery elements 44 is electrically connected to one of the other of the lid units 43, and the second electrode sheet 44b of the remaining battery elements 44 is electrically connected to the remaining one of the lid units 43. As such, the three lid units 43 may be utilized as a part of wiring for electrically connecting the three battery elements 44 in series between the positive electrode 45 and the negative electrode 46, thereby simplifying the entire wiring and thus preventing the device from getting larger due to complex wiring.

Furthermore, the electrochemical device 40 may be configured such that the insulating plates 41c intervenes between the coupling plates 42 as well as the lid units 43, thereby preventing the coupling plates 42 from being in contact with one another, and also preventing the lid units 43 from being in contact with one another. In addition, the plates 41c may facilitate the alignment between the coupling plates 42 and the upper surface of the case 41 as well as the alignment between the lid units 43 and the upper surface of the coupling plates 42.

### OTHER EXAMPLES

The present disclosure is not to be limited in terms of the particular embodiments described in this application, which are intended as illustrations of various aspects. For example, the number of the battery elements disposed in series between positive and negative electrodes is not limited to the numbers described herein. In particular, more than three battery elements may be disposed between positive and negative electrodes in electrically series.

### INDUSTRIAL APPLICABILITY

This application has industrial applicability and can be applied to a variety of uses including various types of electrochemical devices equipped with chargeable and dischargeable battery elements such as electric double layer capacitor, lithium-ion capacitor, redox capacitor, or lithium-ion battery.

What is claimed is:

1. An electrochemical device, comprising:
a case including a plurality of concave portions;
a lid for sealing the plurality of concave portions of the case in a watertight and air tight manner;
a plurality of chargeable and dischargeable battery elements each of which is enclosed into a corresponding one of the sealed plurality of concave portions together with a corresponding electrolytic solution, the plurality of battery elements being connected in series;
a pair of electrodes formed on a mount surface of the case;
a wiring for electrically connecting each of the pair of electrodes to the battery elements; and
an intermediate electrode formed on the mount surface of the case, the intermediate electrode being electrically connected via the wiring to a junction between adjacent two of said plurality of battery elements;
wherein said plurality of battery elements are electrically connected to one another via the wiring between said pair of electrodes.

2. The electrochemical device of claim 1, further comprising a plurality of electrically conductive current collector films formed on a bottom surface of each of said plurality of concave portions,
wherein the lid is configured to be electrically conductive;
wherein a first portion of each of said plurality of battery elements is electrically connected to the current collector films and a second portion of each of said plurality of battery elements having an opposite polarity with respect to that of the first portion is electrically connected to the lid; and
wherein said plurality of battery elements are electrically connected in series between said pair of electrodes via the current collector films, the lid and the wiring.

3. The electrochemical device of claim 2,
wherein the lid includes a plurality of lid units;
wherein a number of the lid is same as that of said plurality of concave portion; and
wherein each of said plurality of lid units seals a corresponding one of said plurality of concave portions.
